(19) United States
(12) Patent Application Publication
(10) Pub. No.: US 2021/0278809 A1
(43) Pub. Date: Sep. 9, 2021

(54) AI-enabled Self-Learning Circuit Breaker

(71) Applicant: Ashok K. Prajapati, Rochester Hills, MI (US)

(72) Inventor: Ashok K. Prajapati, Rochester Hills, MI (US)

(73) Assignee: Ashok K. Prajapati, Rochester Hills, MI (US)

(21) Appl. No.: 17/145,362

(22) Filed: Jan. 10, 2021

Related U.S. Application Data
(60) Provisional application No. 62/959,921, filed on Jan. 11, 2020.

(30) Foreign Application Priority Data
Mar. 2, 2020 (IN) 202011008767

(51) Int. Cl. G05B 13/02; H04W 4/30; G06N 3/04; G06Q 50/06; H02H 1/00

(52) U.S. Cl. CPC G05B 13/027; H04W 4/30; H02H 1/0092; G06Q 50/06; G06N 3/0445

(57) ABSTRACT

The Self-Learning Circuit Breaker (SLCB hereinafter) is invented to control, monitor and optimize the usage of electric energy by a device, equipment, individual or in a group. It includes Industrial IoT (Internet-of-things) to facilitate data collection, transmission to the server and execute control commands. Devices are connected to mobile applications or PC dashboards via highly secured cloud. Heavy data processing is performed in cloud. Device has built-in lightweight AI-based learning capabilities to learn certain behaviors for prompt actions to save the energy usage as well as save equipment from electric fluctuations. Deep learning capabilities help in creating optimal usage profile utilizing demand response, peak shaving, load shedding, and load-displacement. On the other hand, it helps power grids to conserve energy to serve consumers better. SLCB automates the process and results in high-cost saving for home, office, commercial and industrial systems power systems. SLCB's supports single and three-phase systems separately. SLCB mobile app provides seamless access to all connected devices from anywhere.

### CROSS-REFERENCE TO RELATED APPLICATIONS

This application claims the benefit of U.S. Provisional Application No. 62/959,921, filed on Jan. 11, 2020, the entire disclosure of which is incorporated herein by reference.

### FIELD

This invention relates to the field of smart circuit breakers, and more particularly to an AI-powered Self-Learning Circuit Breakers (SLCB hereinafter).

### BACKGROUND

This section provides background information related to the present disclosure which is not necessarily prior art.

There is no any patent found on such circuit breaker in best of our knowledge.

### SUMMARY

The present technology includes system and processes related to measure the energy consumption for connected loads and controlling of individual loads using remotely connected devices such Cellular Phones, Tables or PCs.

Higher energy consumptions have multi-fold side effects in normal human lives and environment. Majority of the power generation is done using fossil fuels which contributes at least two third of the Greenhouse gas emissions. Such emissions also referred as global warming which has well known negative impacts.

Ordinary circuit breakers are designed to prevent connected loads from electrical fluctuations or fire from arc. This device carries all such features and adds ability to do energy measurements, control and smart management of power sources to reduce the grid load.

The present technology enables SLCB to perform energy measurements periodically and save data in local memory. Device is capable of storing data for at least 30 days. Measurement data is then sent at least once a day to the cloud and any command received from user via cloud or self-learned command is executed at real-time basis.

It provides the scheduling ability on individual channels and/or on multi-channel SLCB. SLCB is fully accessible over internet using mobile application or web browser-based dashboard remotely.

Data transmission between SLCB and server is highly secured i.e. over SSL/TLS channel.

Most importantly, SLCB uses AI/ML based learning mechanism in cooperation with cloud to make smart decisions to save energy and do adaptive surge protection.

Cloud generates optimal usage profile learned from data received from SLCB and pushes profile back to the SLCB to follow the optimal schedule. This eventually generates optimized energy usage from the grid and secondary energy sources such as renewable energy.

### DRAWINGS

The detailed understanding of invention can be grasped from figures along with textual explanations.

FIG. 1 illustrates overall top-level architecture for single phase multi-channel SLCB which depicts how each component is connected with SLCB.

FIG. 2. Illustrates the same architecture as in Sec [0014] for 3-phase variant.

### DETAILED DESCRIPTION

The detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

This invention is a self-learning smart circuit breaker (SLCB) backed by Artificial Intelligence/Machine Learning and IoT. It provides a system to carry out normal circuit breaker features, energy measurement, control, smart protection, consumption prediction, secure data transportation over communication interfaces. SLCB can be controlled remotely using mobile application and web-based dashboard. It provides special feature to enable certain switch as always on mode so turning off whole device doesn't turn off those special switches (channels or lines). This feature enables channel to supply power to always on devices like Internet Modem and Routers, Refrigerators etc. Scheduling is one of the very rich features that helps schedule supplies as needed.

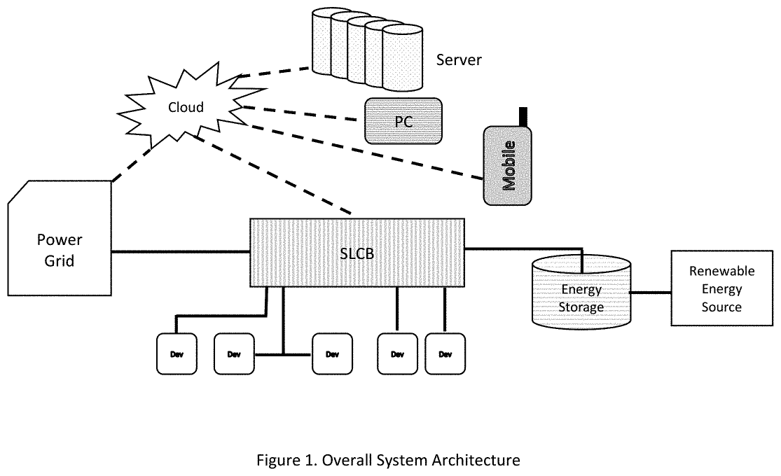

EXAMPLE—with reference to FIG. 1, first embodiment 112 of SLCB 106 applies to single phase electrical use case. Load set 103 consists of multiple loads connected to SLCB for which energy measurement is reported. However, multiple loads 111 are connected to single channel of SLCB. In this case, total consumption of all loads connected to that channel is reported. Similarly, when Cloud sends control command to turn ON/OFF or report latest consumption then SLCB sends information for combined load. Local energy storage system (ESS) 101, stores energy produced by renewable resources 100 such as solar, wind or biogas plants. 102 and 105 are mobile device and PC respectively that is where energy dashboard can be accessed from to see energy consumption and control the loads. Cloud 104 where data is stored and majority of AI/ML operations are carried out. Cloud uses a secure channel to interface with SLCB and Mobile/PC via web 107, 108 and 109 are wireless and wired lines while 110 is power grid where the main supply is coming from.

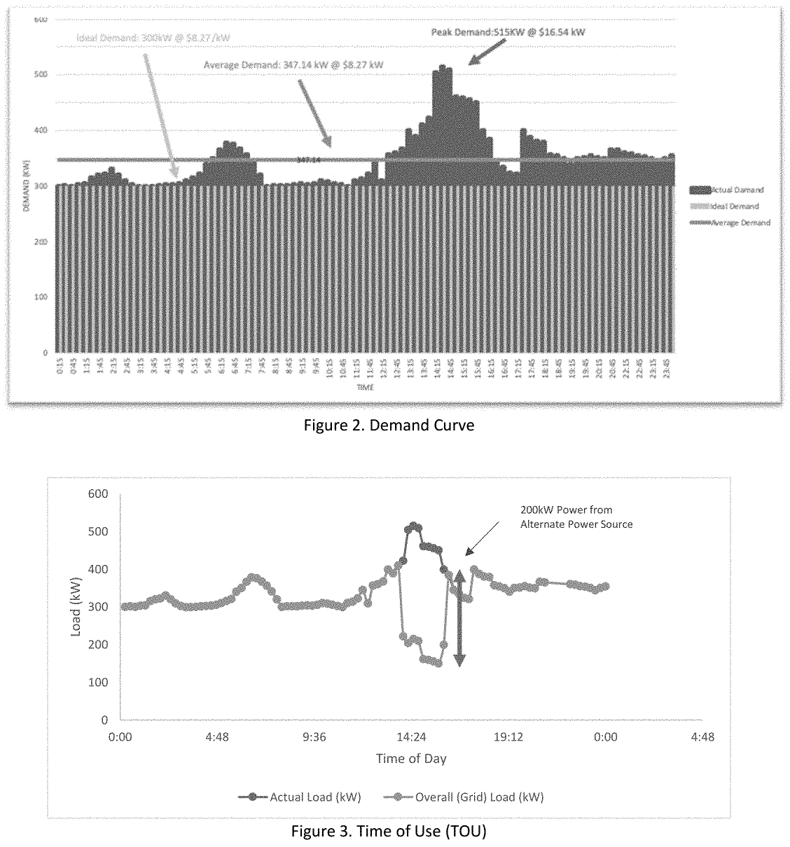

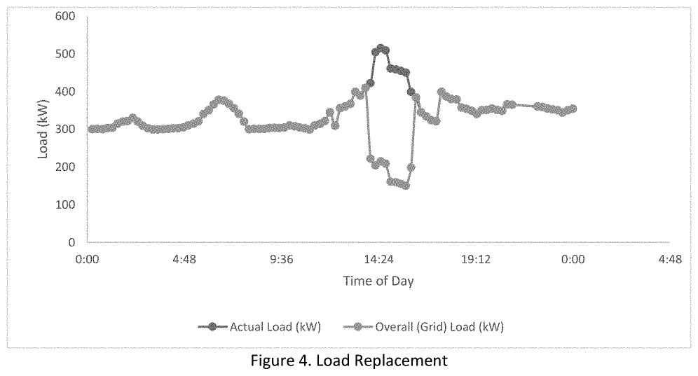

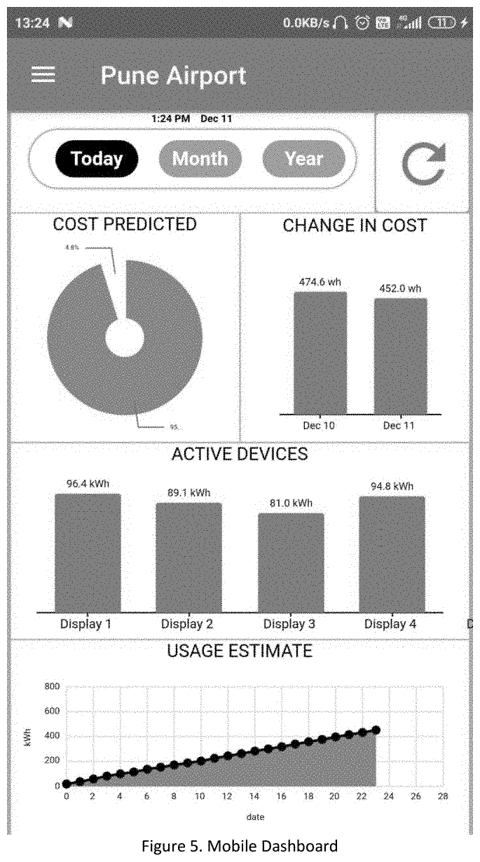

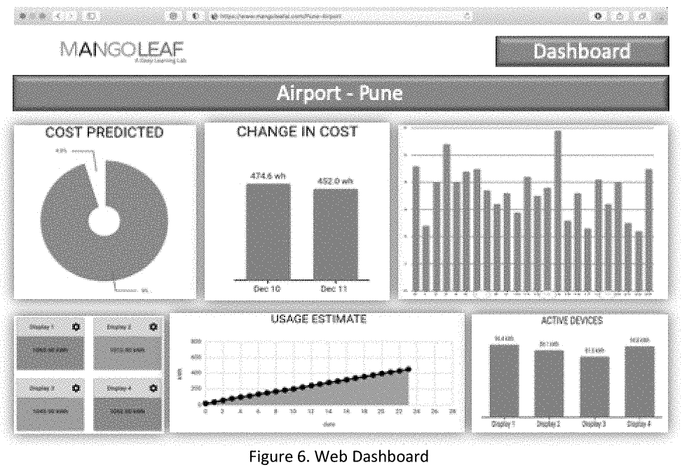

EXAMPLE—with reference to FIG. 2, first embodiment 211 of SLCB 206 applies to three-phase phase electrical use case. Everything else is same as section [0018].

Home IoE Telemetry (HIT) protocol developed in this invention for data transportation for power equipment or home utilities. It is an WiFi/Ethernet/BT/LoRa based protocol. HIT is used in communicating power consumption and control information to SLCB and peer SLCBs. Peer to peer communication helps in developing mesh network for coordination in load balancing and other activities. Scope of HIT protocol is to establish communication between multiple SLCBs.

The system according to invention, SLCB supports mesh networking over LoRa, Bluetooth, WiFi and 4G/5G network interfaces. Mesh network is helpful in employing single gateway to IoE cloud to save cloud bandwidth and additional connectivity at each node.

SLCB contains configurable gateway service that interfaces between LoRa and WiFi/Ethernet/2G/3G/4G/5G. In other words, this device can act as LoRa gateway or repeater as needed for larger commercial settings. Gateway enabled SLCB can receive data from peer devices and send to IoE server via Internet and vice-versa. Mesh network is utilized for this purpose.

SLCB requires some time to learn the load pattern. User input is required to prioritize the equipment or utilities that are used in the load shedding process. A list of devices is maintained in the order utilities can be turned off. It is termed as Shedding Priority. There may be some devices with equal priority. Equal priority devices are used to alternate the load to balance out overall load when there is high grid demand. SLCB attempts the load balancing process in the order below to avoid demand charges and to meet other demand needs.
Load Replacement
Load Shifting
Load Shedding

This device supports various communication protocols to have rich support for various applications. These communication protocols outperform one over other in varying conditions. Following are supported interfaces.
Ethernet
WiFi
Bluetooth
2G/3G/4G/5G
LoRa

Energy consumption prediction is based on Recurrence Neural Network such as LSTM, GRU etc. and some Machine learning techniques like ARIMA. ARIMA like algorithms perform well in smaller data set while RNN has better hold on larger dataset. These predictions help SLCB to present monitory estimate to consumers so they can plan out their future energy usage. Continuous monitoring and prediction help reduce energy consumption in general.

The system according to invention learns the consumer's power supply on/off on channels and prepares an optimize schedule to do it automatically with user confirmation. Once schedule prepared, it is presented to the user and seeks final acceptance before it goes on action.

This system contains Internet of Energy (IoE hereinafter) server. IoE Server (Cloud) is utilized to process data for optimizing usage, usage profile creation, device control and usage monitoring. Cloud interfaces with SLCB and mobile application. They form a complete system altogether. This invention includes a custom cloud development to carry out specialized task and provide better performance. Communication between SLCB and cloud is fully secured to avoid data breach. On the other hand, Mobile app or PC Dashboard is only accessible after proper authentication and authorization.

Extendible message formats are available such as: XML, JSON and Binary.

The system according to invention, mobile application allows usage to be available in kWh and local Currency for better understandability.

The system according to invention allows SLCB to be fully configurable for turning ON/OFF, all or individual channels, bypassing the smart functionality, fault-tolerant, self-configurable, auto-rebooting on special circumstances, and fully reliable.

This technology presents a use case of load optimization involving time of use (TOU) billing scenario. Let's say alternate power can provide up to 400 kW power in 24 hours cycle. SLCB only allows it to use 50% of conserved power and saves 25% for demand response purposes while maintaining 25% cut-off SOC of ESS. Please note that it assumed secondary source such as solar or wind or biogas provides enough power needed by SLCB.

SLCB is made aware of billing slabs but it learns load schedules and their energy requirements over the period to make better decisions on load displacement. Calculation shown in table 1 that assumes alternate power costs same as normal tariffs. It still shows saving of over 20% of total billing. However, alternate energy cost is much lower than grid power cost in reality.

SLCB detects load rise and determines it will cross demand charge limit based on existing data it has. Once it determines replacement condition and switches appropriate loads to alternate energy source. Such reshuffling of loads saves demand charges. However, overall load remains the same but expensive energy consumption is avoided and used from secondary source. Calculation in table 2 presents numerical example to prove significant saving.

In accordance with the provisions of the patent statutes, the present invention has been described in what is considered to represent its preferred embodiment. However, it should be noted that the invention can be practiced otherwise than as specifically illustrated and described without departing from its spirit or scope.

TABLE 1
TOU Comparison Chart

| Billing Rate | Standard Load | SLCB Enabled Load |
|---|---|---|
| Normal Rates (kWh) | $0.009 | $0.009 |
| Peak Rates (kWh) | $0.0388 | $0.0388 |
| Normal Usage (kW) | 300 (5:01PM to | 300 (5:00PM to |
| | 10:59AM) | 11:00AM) |
| Peak Usage (kW) | 600 (11:00AM to | 400 (11:00AM to |
| | 5:00PM) | 2:00PM) |
| Alternate Power(kW) | 0 | 200 (02:00PM to |
| | | 5.00PM) |
| Energy Cost ($) | $25.98 (i.e. | $20.02 (i.e. |
| | 300 × 0.0090 + | (300 + 200) × 0.009 + |
| | 600 × 0.0388) | 400 × 0.0388) |

TABLE 2
Load Replacement Comparison Chart

| Billing Rate | Standard Load | SLCB Enabled Load |
|---|---|---|
| Normal Rates (kWh) | $0.0200 | $0.0200 |
| Demand Charge (kWh) | $0.1302 | $0.13.2 |
| Normal Usage (kW) | 300 | 300 |
| Demand Usage (kW) | 600 | 600 |
| Energy Cost ($) | $84.72 (i.e. 300 × | $18.00 (i.e. (850 + |
| | 0.0200 + | 50) × 0.0200) |
| | 600 × 0.1302) | |

Note: Numbers used here are just representative.

What is claimed is:

1. A Self-Learning Circuit Breaker comprising
A housing
Terminals for input and output supply
Master PCB mounted in housing
PCB consists of
Metrology Unit for measurement
Communication Interfaces including Ethernet, Wifi, 2G/4G/5G, LoRa, Bluetooth Microcontrollers
CT and Relays for controlling lines mounted in housing
Firmware and Software to provide said functions
Internet of Energy (IoE) Cloud for data storage and facilitating the said functions
Mobile Application for accessing the said functions

2. A system/process to provide energy measurement, control and protection (surge) of individual devices (loads) and overall loads connected to power supply, turning ON/OFF connected loads using predetermined or AI/ML based learned schedule and providing notification for alerting user as per configurations.

3. A method for learning and predicting the load conditions to appropriately optimizing power consumption and efficiently using the secondary power sources to reduce the grid power usage.
